(19) United States
(12) Patent Application Publication
(10) Pub. No.: US 2023/0059336 A1
(43) Pub. Date: Feb. 23, 2023

(54) ELECTRICAL CONNECTOR ASSEMBLY

(71) Applicant: PEGATRON CORPORATION, Taipei City (TW)

(72) Inventors: PEI-SHU YEN, TAIPEI CITY (TW); PING-CHUNG LO, TAIPEI CITY (TW); WEI-CHUN TSAO, TAIPEI CITY (TW)

(21) Appl. No.: 17/858,352

(22) Filed: Jul. 6, 2022

(30) Foreign Application Priority Data
Aug. 23, 2021 (TW) 110130979

(51) Int. Cl. H01R 13/6582; H01R 13/648; H01R 24/60; H01R 12/57

(52) U.S. Cl. CPC H01R 13/6582; H01R 13/6485; H01R 24/60; H01R 12/57

(57) ABSTRACT

An electrical connector assembly is applied to be disposed on a circuit board. The electrical connector assembly includes an electrical connector and a grounding metal member that is sleeved around an outer side of the electrical connector. The grounding metal member has a first surrounding segment and a second surrounding segment that outwardly extends from an end of the first surrounding segment. The second surrounding segment has a shielding portion being ring-shaped and a plurality of extension portions that extend from the shielding portion. The grounding metal member is configured to be connected to a grounding circuit of the circuit board through the shielding portion and the extension portions.

### CROSS-REFERENCE TO RELATED PATENT APPLICATION

This application claims the benefit of priority to Taiwan Patent Application No. 110130979, filed on Aug. 23, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a connector, and more particularly to an electrical connector assembly.

### BACKGROUND OF THE DISCLOSURE

A structural configuration of the conventional electrical connector capable of resisting an electromagnetic interference (EMI) has gradually become difficult to meet design requirements when both of the two electrical connectors are applied to transmit the same frequency signals. For example, the two USB dongles are applied to transmit the Wi-Fi 2.4 GHz and Bluetooth 2.4 GHz respectively, and the RF interface is correspondingly produced. Moreover, the conventional electrical connector can no longer effectively filter the EMI with simple designs, such as an absorber that is pasted onto the electrical connector.

### SUMMARY OF THE DISCLOSURE

In response to the above-referenced technical inadequacies, the present disclosure provides an electrical connector assembly to effectively improve on the issues associated with conventional electrical connectors.

In one aspect, the present disclosure provides an electrical connector assembly applied to be disposed on a circuit board. The electrical connector assembly includes an electrical connector and a grounding metal member. The grounding metal member is sleeved around an outer side of the electrical connector. The grounding metal member has a first surrounding segment and a second surrounding segment that outwardly extends from an end of the first surrounding segment. The second surrounding segment has a shielding portion being ring-shaped and a plurality of extension portions that extend from the shielding portion. The grounding metal member is configured to be connected to a grounding circuit of the circuit board through the shielding portion and the extension portions.

In another aspect, the present disclosure provides an electrical connector assembly applied to be disposed on a circuit board. The electrical connector assembly includes an electrical connector and a grounding metal member. The grounding metal member is sleeved around an outer side of the electrical connector. The grounding metal member has a first surrounding segment and a second surrounding segment that outwardly extends from an end of the first surrounding segment. The grounding metal member is configured to be connected to a grounding circuit of the circuit board through the second surrounding segment.

Therefore, the electrical connector assembly of the present disclosure is provided with the grounding metal member surrounding the electrical connector, thereby effectively reducing an effect of external EMI on the electrical connector while maintaining the signal transmission quality of the electrical connector, without changing the structural configuration of the electrical connector.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective view of an electrical connector assembly disposed on a circuit board according to an embodiment of the present disclosure;

FIG. 2 is an exploded view of FIG. 1;

FIG. 3 is a perspective view of the electrical connector assembly according to the embodiment of the present disclosure;

FIG. 4 is an exploded view of FIG. 3;

FIG. 5 is a cross-sectional view of FIG. 3;

FIG. 6 is a cross-sectional view taken along line VI-VI of FIG. 3;

FIG. 7 is a cross-sectional view taken along line VII-VII of FIG. 3;

and

FIG. 8 is a cross-sectional view taken along line VIII-VIII of FIG. 3.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

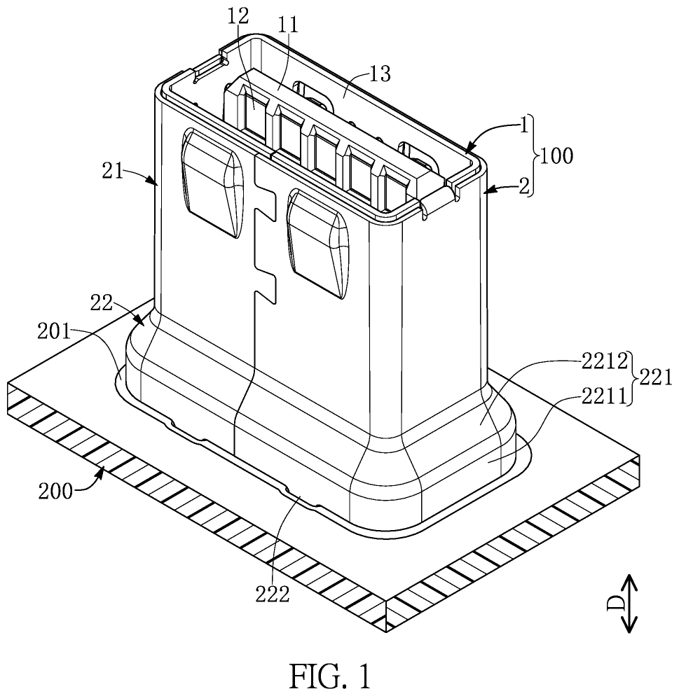

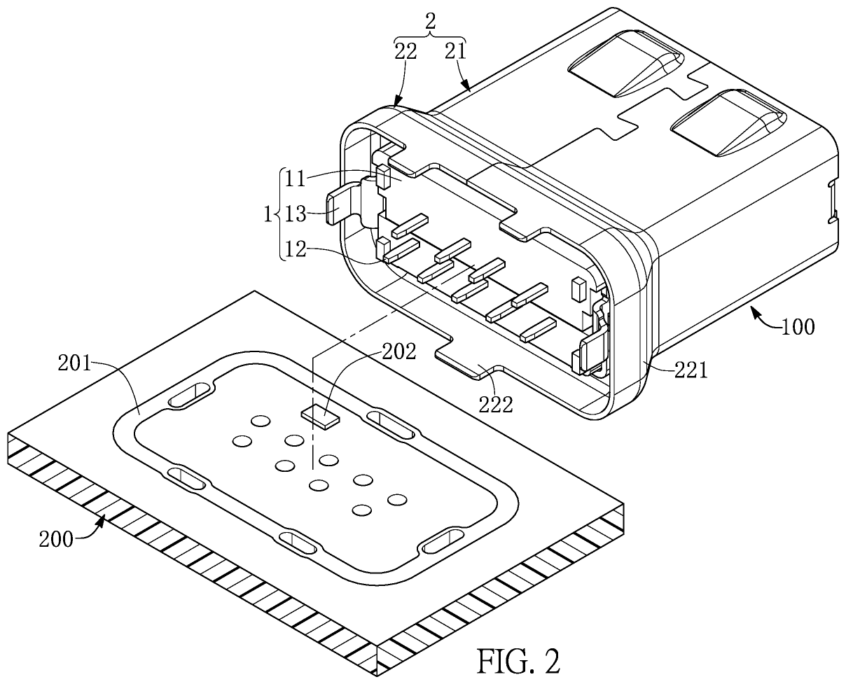

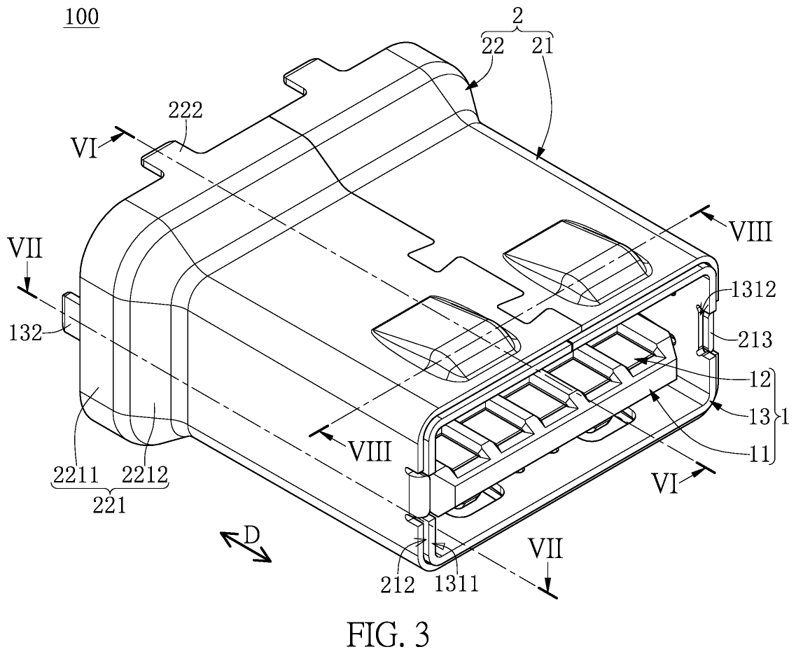

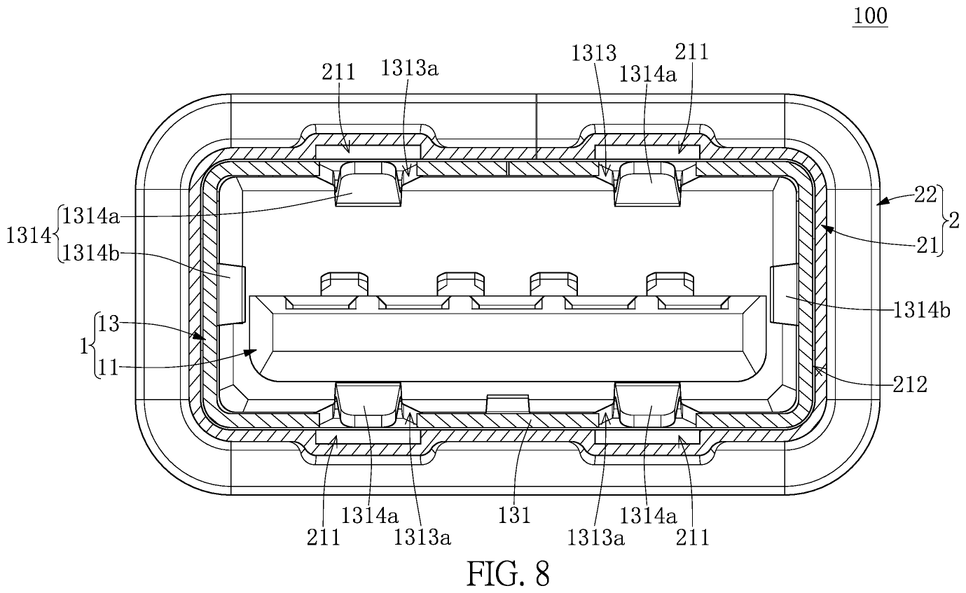

Referring to FIG. 1 to FIG. 8, an embodiment of the present disclosure provides an electrical connector assembly 100. As shown in FIG. 1 and FIG. 2, the electrical connector assembly 100 of the present embodiment is applied to be disposed on a circuit board 200. It should be noted that the circuit board 200 in the present embodiment includes a grounding circuit 201, and an electrostatic discharge (ESD) member 202 is disposed on the circuit board 200. The grounding circuit 201 of the circuit board 200 preferably has a closed-loop shape, the ESD member 202 is located within the closed-loop shape of the grounding circuit 201, and the grounding circuit 201 and the ESD member 202 are exposed from (or located at) a mounting surface of the circuit board 200, but the present disclosure is not limited thereto.

As shown in FIG. 2 to FIG. 4, the electrical connector assembly 100 includes an electrical connector 1 and a grounding metal member 2 that is sleeved around an outer side of the electrical connector 1. The electrical connector 1 in the present embodiment is a vertical type connector and preferably meets a USB Type-A standard, but the present disclosure is not limited thereto. For example, as shown in FIG. 2, the electrical connector 1 is vertically assembled to the circuit board 200 in a pin-in-paste (PIP) manner.

In the present embodiment, the electrical connector 1 is fixed and electrically coupled to the circuit board 200, and the electrical connector 1 includes an insulating base 11, a plurality of conductive terminals 12 fixed to the insulating base 11, and a metal housing 13 that is sleeved around outer sides of the insulating base 11 and the conductive terminals 12. The conductive terminals 12 are inserted into and electrically coupled to the circuit board 200, and the type of any one of the conductive terminals 12 can be selected based on design requirements. For example, the conductive terminals 12 of the electrical connector 1 can include at least one differential terminal pair inserted into the circuit board 200.

Moreover, the metal housing 13 is integrally formed as a single one-piece structure (e.g., the metal housing 13 is formed by punching a single metal sheet and connecting two opposite ends of the single metal sheet). The metal housing 13 has a main portion 131 and a plurality of connection portions 132 that extend from the main portion 131. The main portion 131 is a rectangular frame having two long segments and two short segments. A part of each of the conductive terminals 12 is inserted into the circuit board 200, and the other part of each of the conductive terminals 12 is located in a space surroundingly defined by the main portion 131 of the metal housing 13.

The connection portions 132 of the present embodiment are two L-shaped structures substantially located in an arrangement direction of the conductive terminals 12, and the metal housing 13 is connected to the grounding circuit 201 by using the connection portions 132 to be inserted into the circuit board 200. The two L-shaped connection portions 132 are respectively connected to the two short segments of the main portion 131. Since each of the connection portions 132 is substantially L-shaped, an outer surface of each of the connection portions 132 is not coplanar with an outer surface of the main portion 131, and the connection portions 132 outwardly extend from the two short segments of the main portion 131, respectively. Accordingly, the electrical connector 1 can be firmly inserted into the circuit board 200 through the connection portions 132. In the present embodiment, the connection portions 132 are connected to the grounding circuit 201 by being inserted into the circuit board 200 in the PIP manner, but the present disclosure is not limited thereto.

Specifically, the metal housing 13 has a plurality of notches 1312 (e.g., two notches 1312) arranged away from the circuit board 200 (or the connection portions 132). The notches 1312 in the present embodiment are recessed in an edge 1311 of the main portion 131 away from the connection portions 132, and respectively correspond in position to the connection portions 132. Moreover, the two notches 1312 and the two connection portions 132 are respectively arranged on two opposite sides of the two short segments of the main portion 13 (e.g., the two notches 1312 are arranged on one side of the two short segments of the main portion 13, and the two connection portions 132 are arranged on an opposite side of the two short segments of the main portion 13), but the present disclosure is not limited thereto.

Furthermore, the metal housing 13 has a plurality of slits 1313. The slits 1313 in the present embodiment are formed in the two long segments and the two short segments of the main portion 13, and are arranged adjacent to the edge 1311 of the main portion 131 that is adjacent to an opening of the main portion 131. Specifically, the slits 1313 can be divided into a plurality of first slits 1313a and two second slits 1313b. The first slits 1313a are arranged on the two long segments of the main portion 131, the two second slits 1313b are arranged on the two short segments of the main portion 131, the first slits 1313a and the two second slits 1313b are staggered with each other to jointly form a loop-shaped arrangement, and the two second slits 1313b are respectively arranged adjacent to the two notches 1312.

Moreover, the main portion 131 of the metal housing 13 has a plurality of elastic arms 1314 respectively located in the slits 1313. The elastic arm 1314 located in any one of the first slits 1313a is defined as a first elastic arm 1314a, and the elastic arm 1314 located in any one of the two second slits 1313b is defined as a second elastic arm 1314b. When an object (e.g., an electrical card or a connector) is inserted into the electrical connector 1 along an insertion direction D, the elastic arms 1314 are elastically swingable to abut against the object.

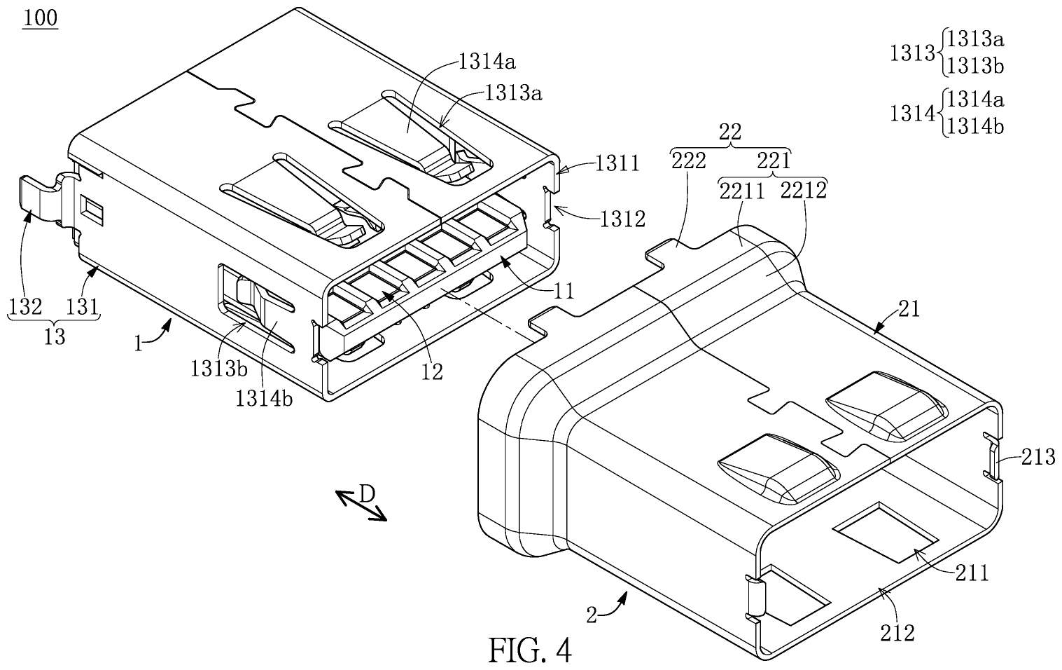

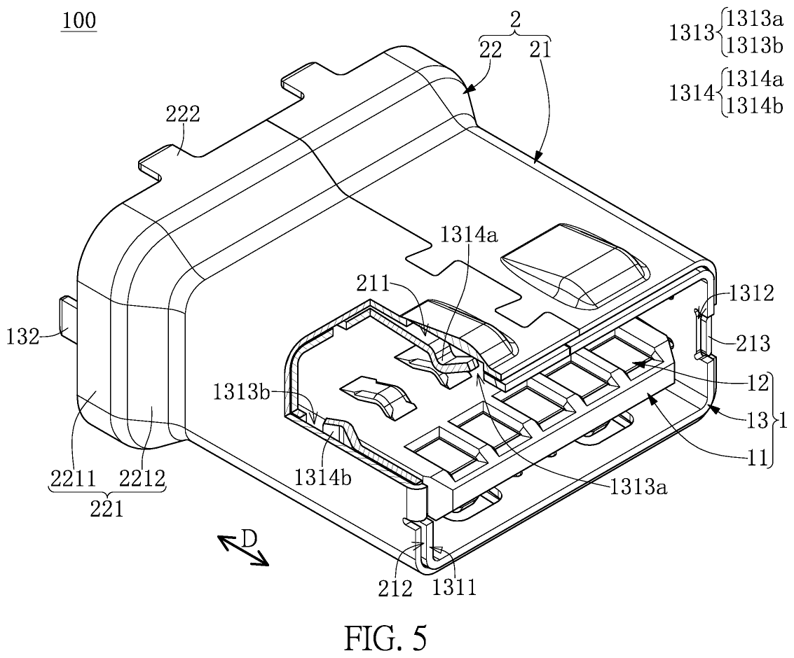

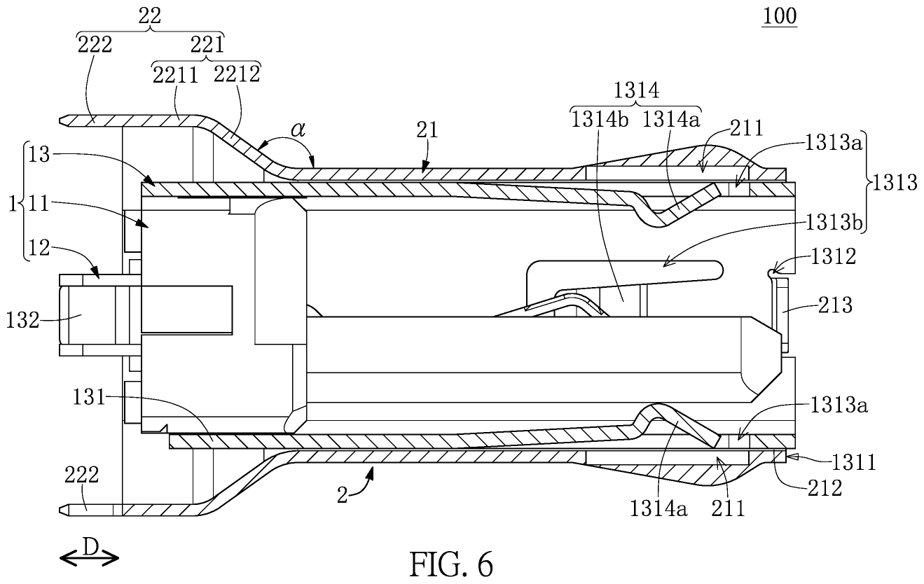

As shown in FIG. 2, FIG. 4, and FIG. 5, the grounding metal member 2 is integrally formed as a single one-piece structure (e.g., the grounding metal member 2 is formed by punching a single metal sheet and connecting two opposite ends of the single metal sheet), and the grounding metal member 2 is sleeved around an outer side of the metal housing 13 along the insertion direction D. In the present embodiment, no thru-hole is formed in the grounding metal member 2, and at least 95% of a volume of the electrical connector 1 is accommodated in a space defined by the grounding metal member 2 and the electrical connector 1 is surrounded by the grounding metal member 2 (as shown in FIG. 6 to FIG. 8). In other words, a portion of the electrical connector 1 not arranged in the space surroundingly defined by the grounding metal member 2 only includes the part of each of the conductive terminals 12 inserted into the circuit board 200, but the present disclosure is not limited thereto.

The grounding metal member 2 has a first surrounding segment 21 and a second surrounding segment 22 that outwardly extends from an end of the first surrounding segment 21. In the present embodiment, the first surrounding segment 21 is arranged adjacent to the main portion 131 of the metal housing 13, and the second surrounding segment 22 gradually extends from the first surrounding segment 21 along a direction away from the metal housing 13. Accordingly, along a direction perpendicular to the insertion direction D, a cross-sectional area of a space surroundingly defined by the second surrounding segment 22 is greater than a cross-sectional area of a space surroundingly defined by the first surrounding segment 21. In other words, a projection defined by orthogonally projecting the first surrounding segment 21 onto the circuit board 200 is defined as a first region, a projection defined by orthogonally projecting the second surrounding segment 22 onto the circuit board 200 is defined as a second region, and an area of the second region is greater than an area of the first region. It should be noted that no thru-hole is formed in the first surrounding segment 21 and the second surrounding segment 21, so that the electrical connector 1 is shielded and surrounded by the grounding metal member 2.

Accordingly, the electrical connector assembly 100 in the present embodiment is provided with the grounding metal member 2 surrounding the electrical connector 1, thereby effectively reducing an effect of external EMI on the electrical connector 1 while maintaining the signal transmission quality of the electrical connector 1 without changing the structure of the electrical connector 1.

Specifically, the first surrounding segment 21 covers the slits 1313 of the metal housing 13, thereby effectively reducing the external EMI that affects the electrical connector 1 through the slits 1313. Moreover, the first surrounding segment 21 has a plurality of concavities 211 that are formed in an inner surface thereof and that respectively correspond in position to the first elastic arms 1314a, and a portion of the first surrounding segment 21 corresponding in position to the two second elastic arms 1314b is in a planar shape, but the present disclosure is not limited thereto. For example, in other embodiments of the present disclosure not shown in the drawings, the first surrounding segment 21 can have at least one concavity 211 corresponding in position to at least one of the elastic arms 1314.

Accordingly, any one of the concavities 211 can provide a space that allows the corresponding first elastic arm 1314a to be swingable therein, and any one of the concavities 211 can be in contact with the corresponding first elastic arm 1314a, so that the grounding metal member 2 and the metal housing 13 are commonly grounded for improving an EMI.

In addition, the first surrounding segment 21 has an opening 212 arranged adjacent to the notches 1312, and the edge 1311 of the metal housing 13 protrudes from the opening 212. In the present embodiment, the first surrounding segment 21 has a plurality of retaining portions 213 that correspond in position to the opening 212 and that are two J-shaped structures facing each other, and the retaining portions 213 are respectively located in the notches 1312, thereby maintaining the relative position of the grounding metal member 2 and the metal housing 13.

The second surrounding segment 22 has a shielding portion 221 being ring-shaped and a plurality of extension portions 222 that extend from the shielding portion 221 along a direction away from the opening 212. The shielding portion 221 outwardly extends from the first surrounding segment 21 so as to surround the outer sides of the conductive terminals 12 (e.g., the at least one differential terminal pair), thereby covering (or shielding) the conductive terminals 12 (e.g., the at least one differential terminal pair), but the present disclosure is not limited thereto. For example, in other embodiments of the present disclosure not shown in the drawings, the second surrounding segment 22 can be provided without the extension portions 222 or can have only one of the extension portions 222.

The grounding metal member 2 is connected to the grounding circuit 201 of the circuit board 200 along the insertion direction D through the shielding portion 221 and the extension portions 222, so that the opening 212 of the first surrounding segment 21 is parallel to the mounting surface of the circuit board 200, and the metal housing 13 and the grounding metal member 2 are commonly grounded. It should be noted that a distal edge contour of the shielding portion 221 of the second surrounding segment 22 is substantially identical to a contour of the grounding circuit 201.

In the present embodiment, a distal edge of the shielding portion 221 arranged away from the first surrounding segment 21 is connected to the grounding circuit 201, the ESD member 202 is located in a space surroundingly defined by the shielding portion 221, and the extension portions 222 are inserted into the grounding circuit 201 in the PIP manner, but the present disclosure is not limited thereto.

Accordingly, the grounding metal member 2 and the metal housing 13 of the electrical connector assembly 100 can be commonly grounded through the circuit board 200 so as to effectively improve the EMI. Moreover, by means of the structural design of the second surrounding segment 22, a space surroundingly defined by the shielding portion 221 of the grounding metal member 2 can be provided for accommodating the ESD member 202, thereby improving the EMI for the electrical connector assembly 100. In addition, the space surroundingly defined by the shielding portion 221 can allow other electronic components to be arranged therein, but the present disclosure is not limited thereto.

Specifically, the structure of the shielding portion 221 can be adjusted or changed according to design requirements, and the present embodiment only describes one exemplary structure of the shielding portion 221, but the present disclosure is not limited thereto. The shielding portion 221 has an extending section 2211 and an expanding section 2212. The extension portions 222 are connected to the extending section 2211, and the expanding section 2212 slantingly connects the first surrounding segment 21 and the extending section 2211.

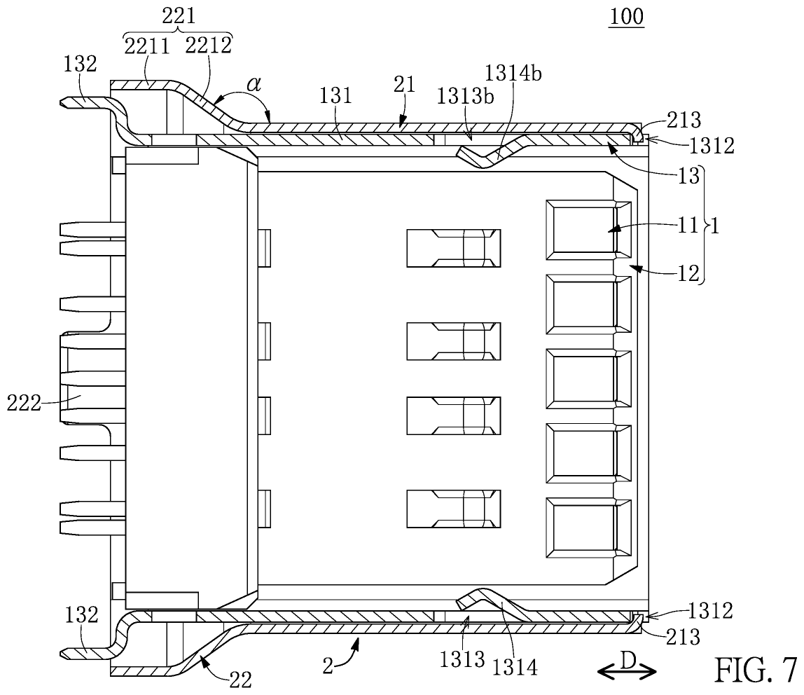

Moreover, an angle α (as shown in FIG. 6 and FIG. 7) between the expanding section 2212 and the first surrounding segment 21 is within a range from 100 degrees to 170 degrees, and is substantially equal to an angle between the expanding section 2212 and the extending section 2211. In other words, along a direction perpendicular to the insertion direction D, a region surrounded by the expanding section 2212 gradually increases from the first surrounding segment 21 toward the extending section 2211, but the present disclosure is not limited thereto. For example, in other embodiments of the present disclosure not shown in the drawings, the expanding section 2212 can perpendicularly connect the first surrounding segment 21 and the extending section 2211.

### BENEFICIAL EFFECTS OF THE EMBODIMENT

In conclusion, the electrical connector assembly of the present disclosure is provided with the grounding metal member surrounding the electrical connector, thereby effectively reducing an effect of an external EMI on the electrical connector while maintaining the signal transmission quality of the electrical connector, without changing the structural configuration of the electrical connector.

Specifically, the grounding metal member and the metal housing of the electrical connector assembly provided by the present disclosure can be commonly grounded through the circuit board so as to effectively improve the EMI. Moreover, by means of the structural design of the second surrounding segment, a space surroundingly defined by the shielding portion of the grounding metal member can be provided for accommodating the ESD member, thereby improving the EMI for the electrical connector assembly.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electrical connector assembly applied to be disposed on a circuit board, the electrical connector assembly comprising:
an electrical connector; and
a grounding metal member sleeved around an outer side of the electrical connector, the grounding metal member having a first surrounding segment and a second surrounding segment that outwardly extends from an end of the first surrounding segment, and the second surrounding segment having a shielding portion being ring-shaped and a plurality of extension portions that extend from the shielding portion;
wherein the grounding metal member is configured to be connected to a grounding circuit of the circuit board through the shielding portion and the plurality of extension portions.

2. The electrical connector assembly according to claim 1, wherein the grounding circuit is exposed from a mounting surface of the circuit board, the plurality of extension portions are configured to be connected to the grounding circuit by being inserted into the circuit board in a pin-in-paste manner, and a distal edge of the shielding portion arranged away from the first surrounding segment is configured to be connected to the grounding circuit.

3. The electrical connector assembly according to claim 1, further comprising an electrostatic discharge member, wherein the electrostatic discharge member is disposed on the circuit board and is accommodated in a space surroundingly defined by the shielding portion.

4. The electrical connector assembly according to claim 1, wherein no thru-hole is formed in the first surrounding segment and the second surrounding segment, and at least 95% of a volume of the electrical connector is accommodated in a space defined by the grounding metal member and the electrical connector is surrounded by the grounding metal member.

5. The electrical connector assembly according to claim 1, wherein the shielding portion has an extending section and an expanding section, the plurality of extension portions are connected to the extending section, and the expanding section slantingly connects the first surrounding segment and the extending section, and an angle between the expanding section and the first surrounding segment is within a range from 100 degrees to 170 degrees.

6. The electrical connector assembly according to claim 1, wherein a projection defined by orthogonally projecting the first surrounding segment onto the circuit board is defined as a first region, a projection defined by orthogonally projecting the second surrounding segment onto the circuit board is defined as a second region, and an area of the second region is greater than that of the first region.

7. The electrical connector assembly according to claim 1, wherein the electrical connector meets a USB Type-A standard and includes:
an insulating base;
a plurality of conductive terminals fixed to the insulating base and configured to be electrically connected to the circuit board; and
a metal housing having a main portion and a plurality of connection portions that extend from the main portion, the metal housing being sleeved around outer sides of the insulating base and the plurality of conductive terminals, wherein the grounding metal member is sleeved around an outer side of the metal housing, wherein the metal housing is configured to be connected to the grounding circuit by the plurality of connection portions inserted into the circuit board, so that the metal housing and the grounding metal member are commonly grounded through the grounding circuit.

8. The electrical connector assembly according to claim 7, wherein a part of each of the plurality of conductive terminals is inserted into the circuit board, and the other part of each of the plurality of conductive terminals is located in a space surroundingly defined by the main portion of the metal housing.

9. The electrical connector assembly according to claim 7, wherein an edge of the main portion has a plurality of notches arranged away from the plurality of connection portions, and the first surrounding segment of the grounding metal member has a plurality of retaining portions respectively located in the plurality of notches.

10. The electrical connector assembly according to claim 9, wherein the main portion of the metal housing is a rectangular frame having two long segments and two short segments, the plurality of notches are arranged on one side of the two short segments of the main portion, and the plurality of connection portions are arranged on an opposite side of the two short segments of the main portion.

11. The electrical connector assembly according to claim 10, wherein the plurality of connection portions are two L-shaped structures substantially located in an arrangement direction of the plurality of conductive terminals, the plurality of connection portions outwardly extend from the two short segments of the main portion, respectively, and an outer surface of each of the plurality of connection portions is not coplanar with an outer surface of the main portion.

12. The electrical connector assembly according to claim 11, wherein the main portion of the metal housing has a plurality of slits and a plurality of elastic arms that are respectively located in the plurality of slits, the first surrounding segment covers the plurality of slits, and at least one concavity formed in an inner surface of the first surrounding segment corresponds in position to one of the plurality of elastic arms.

13. The electrical connector assembly according to claim 12, wherein the plurality of slits include a plurality of first slits and two second slits, the plurality of first slits are arranged on the two long segments of the main portion, the two second slits are arranged on the two short segments of the main portion, the plurality of first slits and the two second slits are staggered with each other to jointly form a loop-shaped arrangement, and the two second slits are respectively arranged adjacent to the plurality of notches.

14. The electrical connector assembly according to claim 7, wherein the plurality of conductive terminals include at least one differential terminal pair configured to be inserted into the circuit board, and the shielding portion of the second surrounding segment surrounds an outer side of the at least one differential terminal pair so as to shield the at least one differential terminal pair.

15. The electrical connector assembly according to claim 1, wherein the electrical connector is a vertical type connector, and the first surrounding segment of the grounding metal member has an opening that is arranged away from the plurality of extension portions and the opening is configured to be parallel to a mounting surface of the circuit board.

16. The electrical connector assembly according to claim 1, wherein the grounding metal member is configured to be connected to the grounding circuit of the circuit board through the shielding portion, and a distal edge contour of the shielding portion is configured to be substantially identical to a contour of the grounding circuit of the circuit board.

17. An electrical connector assembly applied to be disposed on a circuit board, the electrical connector assembly comprising:
an electrical connector; and
a grounding metal member sleeved around an outer side of the electrical connector, the grounding metal member having a first surrounding segment and a second surrounding segment that outwardly extends from an end of the first surrounding segment;
wherein the grounding metal member is configured to be connected to a grounding circuit of the circuit board through the second surrounding segment.
